(19) United States
(12) Patent Application Publication
(10) Pub. No.: US 2001/0015249 A1
(43) Pub. Date: Aug. 23, 2001

(54) Woven felly tube for attaching a sound-absorbing body

(75) Inventor: Christoph Mohr, Wuppertal (DE)

Correspondence Address: THE FIRM OF KARL F ROSS, 5676 RIVERDALE AVENUE, PO BOX 900, RIVERDALE (BRONX), NY, 10471-0900, US

(73) Assignee: AUGUST MOHR GMBH & CO. KG

(21) Appl. No.: 09/785,038

(22) Filed: Feb. 16, 2001

(30) Foreign Application Priority Data
Feb. 18, 2000 (DE) 10007375.1

(51) Int. Cl. B60C 15/02

(52) U.S. Cl. 152/381.6

(57) ABSTRACT

A felly tube holds, by shrinkage, a sound-absorbing body in the felly of a wheel adapted to carry a pneumatic tire. The felly tube is woven with a central region which is more tightly woven than a pair of selvage regions which have greater-length weft floats. The shrinkable threads are incorporated as a warp of the selvage regions.

### FIELD OF THE INVENTION

My present invention relates to a felly or ring tube of textile material and which serves for affixing at least one sound-absorbing body to the felly or rim of a wheel carrying a pneumatic tire. More particularly, the invention relates to a felly or rim tube of this type which has a circumferential central region flanked on opposite sides by selvage regions which contain or are composed of heat-shrinkable and/or moisture shrinkable textile threads and whereby the weight of the material per unit area in the selvage regions is significantly greater than the material weight per unit area.

### BACKGROUND OF THE INVENTION

An endless felly tube or hose composed of textile material can be produced by conventional textile processes and can be stitched in the selvage region, e.g. after the sound-absorbing element is introduced and ends of the tube can be joined together, also by stitching to anchor the sound-damping material to the rim or felly of a pneumatic tire wheel. In the selvage regions, before wrapping of the sound-absorbing body and stitching, 60 mutually parallel yarns of polyvinylalcohol (PVA) can be laid in and by subsequent shrinkage under heat or moisture can ensure a firm seating of the tube and the sound-absorbing body against the floor of the felly or rim.

The process for mounting the sound-damping or sound-absorbing body on the felly or rim requires numerous steps and is relatively expensive. In spite of the fact that shrinkage is used, the tube and the sound absorber frequently are not held with sufficient firmness.

### OBJECTS OF THE INVENTION

It is, therefore, the principal object of the present invention to provide an improved felly or rim tube whereby the disadvantages of the earlier system can be obviated.

It is another object of the invention to provide an inexpensive felly tube which, upon the application of heat or moisture can ensure a firm, satisfactory and permanent mounting of the sound absorber against the floor of the rim or felly.

### SUMMARY OF THE INVENTION

These objects and others which will become apparent hereinafter are attained, in accordance with the invention with a woven felly tube of textile material for securing a sound absorbing body to the felly of a wheel adapted to receive a pneumatic tire, the felly tube consisting of a circumferentially extending central region flanked on opposite sides by selvage regions consisting at least in part of moisture or heat shrinkable threads. The weight per unit area of the material being substantially greater in the selvage regions than in the central region, the moisture or heat shrinkable threads being woven into the selvage regions. The woven felly tube has a change of cross-weaving binding type in a transition between the central region and each of the selvage regions, the cross-weaving binding type in the selvage region having longer weft floats than in the central region.

It is important to the present invention that the moisture or heat shrinkable thread be woven into selvage regions of the felly tube flanking the central region, that in the transition between the central region and the selvage region there be a change in the cross weave binding type and that the cross weave binding type in the selvage region has longer floats in the weft than in the central region.

A surprising advantage of the invention is that it is possible to weave the felly tube in a single step in spite of the fact that the central region and the selvage regions has significant differences in weight per unit area. The selvage regions integrate the shrinkable textile threads fully therein and are firmly connected to the central region while the selvage regions because of the longer weft floats and fewer binding points is capable of a high degree of shrinkage so that a very firm attachment of the felly tube to the wheel rim is ensured.

Best results are obtained when the number of binding points per unit area is at least halved in the selvage region from that in the central region.

According to another feature of the invention the selvage region in the warp direction is substantially completely composed of shrinkable textile threads.

It has been found to be advantageous, in accordance with the invention to form the selvage regions with a linen hollow binding which has the advantage of an especially effective distribution of mass. Best results are obtained with atlas, twill or fancy patterns.

### BRIEF DESCRIPTION OF THE DRAWING

The above and other objects, features, and advantages will become more readily apparent from the following description, reference being made to the accompanying drawing in which:

FIG. 1 is a diagram of the felly tube of the invention in cross section;

FIG. 2 is a weave pattern for the felly tube; and

FIG. 3 is a cross section through a wheel provided with the felly tube of the invention.

### SPECIFIC DESCRIPTION

Referring first to FIG. 3, it can be seen that a wheel 100, e.g. for an automotive vehicle, can be formed with a felly 101 and a wheel disk 102, the felly carrying a pneumatic tire 103 and a sound-absorbing body 104, the latter being held in a tube 105 of a textile material and containing shrinkable threads. The threads are shrunk after the body 104 has been enclosed in the woven material and the ring formed by the body and the woven material has been stitched closed. The result is that the ring fits snugly on the felly. The tire 103 is then mounted.

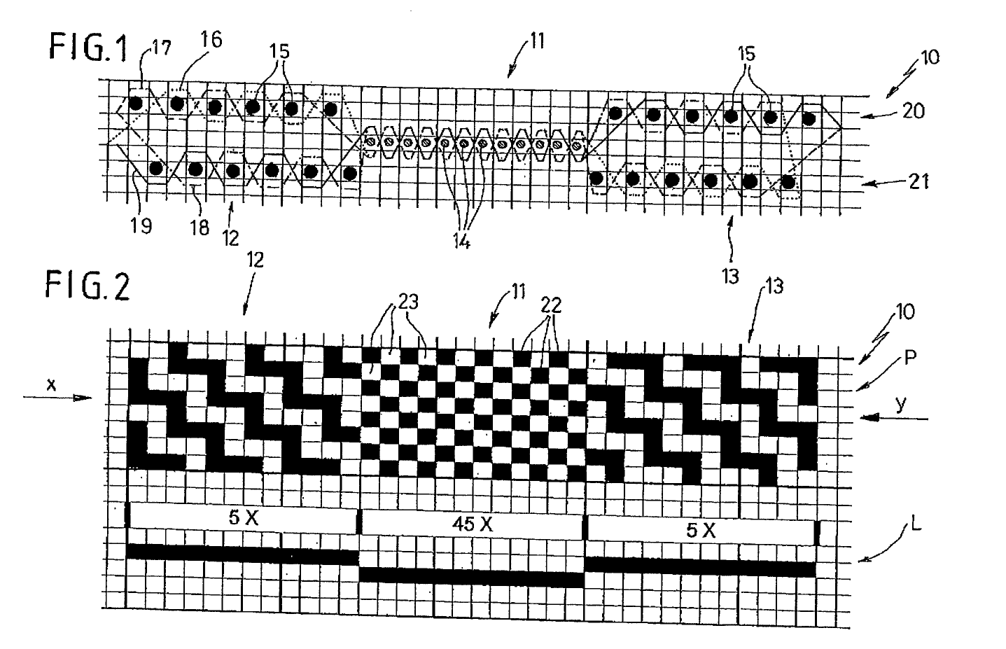

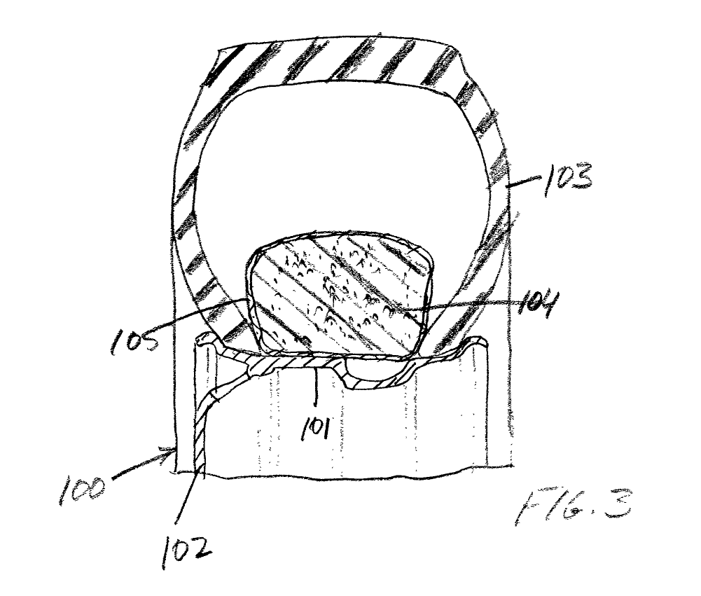

The felly tube forming the member 105 is composed of textile material and has been represented at 10 in FIGS. 1 and 2, FIG. 2 being a point-paper pattern illustrating the weave.

The fabric tube is formed as an endless strip from which lengths are cut for each felly and then stitched to close the ends after the body 104 is introduced. The tube 10 has a central region 11 and two selvage regions 12 and 13. While the central region 11 may be composed of nylon (detex 110), the selvage regions 12 and 13 are composed of polyvinylalcohol threads (PVA, detex 1100).

FIG. 1 is a diagram representing a cross section through the felly tube 10. From this Figure, the warp threads 14 of the central region 11 as well as the warp threads 15 of the selvage regions 12 can be distinguished and are engaged by four weft threads 16, 17, 18 and 19 alternately passing over an end of the warp threads. The individual weft threads can be distinguished as follows:

Weft thread 16 . . .

Weft thread 17 - - -

Weft thread 18 - . -

Weft thread 19 ___

The warp threads 15 of the selvage regions 12 and 13, which are composed of PVA, can be some ten times greater in cross section than the warp threads 14 of the central region 11.

FIGS. 1 and 2 thus show, on the point-paper pattern P, a felly tube 10 which has different types of cross weave binding in the central region and the selvage region 12. While in the central region 11 a linen type of cross weave binding prevails, in the selvage regions 12 and 13, a linen hollow binding is provided with longer weft floats and thus greater binding-free lengths. With the hose-like binding in the selvage regions 12 and 13, there is a greater dispersal of the larger cross section whereby yarns 15 in an upper region 20 and a lower region 21 proving a uniform transition from the central region 11 to the selvage region 12 in spite of the significant difference in warp thread cross sections. The result is that the warp yarns 15 are bound less tightly and hence the woven structure does not hinder the shrinkage of the threads 15.

In a plan view, as represented by the point paper diagram P of FIG. 2, it can be seen that the central region 11 has substantially more binding points (crossings) per unit area then do the selvage regions 12 and 13 which have a looser binding with large binding-free areas. The bindings are represented by the black-filled regions of the drawing.

In the region x of the diagrams P represents the weft insertion region while the region y represents the looping side in which the weft is engaged by the weft hook. The pattern P also has an information strip L which indicates the number of warp threads in the selvage regions 12 and 13 and the central region 11. Thus the selvage regions 12, 13 each have five×(12) warp threads 15 while the central region 11 comprises 45×(12) warp threads 14.

I claim:

1. A woven felly tube of textile material for securing a sound absorbing body to the felly of a wheel adapted to receive a pneumatic tire, said felly tube consisting of a circumferentially extending central region flanked on opposite sides by selvage regions consisting at least in part of moisture or heat shrinkable threads, the weight per unit area of said material being substantially greater in said selvage regions than in said central region, said moisture or heat shrinkable threads being woven into said selvage regions, said woven felly tube having a change of cross-weaving binding type in a transition between the central region and each of the selvage regions, the cross-weaving binding type in said selvage region having longer weft floats than in said central region.

2. The woven felly tube defined in claim 1 wherein the number of binding points per unit area of said selvage regions is at least half the number of binding points per unit area of said central region.

3. The woven felly tube defined in claim 1 wherein the threads constituting said selvage regions in the warp direction are substantially all shrinkable textile threads.

4. The woven felly tube defined in claim 1 wherein said selvage regions have a hollow hose cross-weave binding pattern.

5. The woven felly tube defined in claim 1 wherein said selvage regions have an atlas binding pattern.

6. The woven felly tube defined in claim 1 wherein said selvage regions have a twill binding pattern.

7. The woven felly tube defined in claim 1 wherein said selvage regions have a fancy marking pattern.

8. The woven felly tube defined in claim 1 wherein said selvage regions have a weight per unit area which is at least eight times the weight per unit area of said central region.

9. The woven felly tube defined in claim 1 wherein all the weft threads and warp threads of said central region are composed of nylon and the shrinkable warp threads of the selvage regions are composed of polyvinylalcohol.

10. The woven felly tube defined in claim 1 wherein all the weft threads and warp threads of said central region are composed of polyester and the shrinkable warp threads of the selvage regions are composed of polyvinylalcohol.

11. A wheel assembly comprising:
a wheel having a felly;
a sound absorbing body mounted in said felly;
a woven felly tube of textile material securing said sound absorbing body to said felly, said felly tube consisting of a circumferentially extending central region flanked on opposite sides by selvage regions consisting at least in part of moisture or heat shrinkable threads, the weight per unit area of said material being substantially greater in said selvage regions than in said central region, said moisture or heat shrinkable threads being woven into said selvage regions, said woven felly tube having a change of cross-weaving binding type in a transition between the central region and each of the selvage regions, the cross-weaving binding type in said selvage region having longer weft floats than in said central region, said threads being shrunk to retain said body on said felly; and
a pneumatic tire mounted on said felly and enclosing said felly tube and said body.

12. The wheel assembly defined in claim 11 wherein the number of binding points per unit area of said selvage regions is at least half the number of binding points per unit area of said central region.

13. The wheel assembly defined in claim 11 wherein the threads constituting said selvage regions in the warp direction are substantially all shrinkable textile threads.

14. The wheel assembly defined in claim 11 wherein said selvage regions have a hollow hose cross-weave binding pattern.

15. The wheel assembly defined in claim 11 wherein said selvage regions have an atlas binding pattern.

16. The wheel assembly defined in claim 11 wherein said selvage regions have a twill binding pattern.

17. The wheel assembly defined in claim 11 wherein said selvage regions have a fancy marking pattern.

18. The wheel assembly defined in claim 11 wherein said selvage regions have a weight per unit area which is at least eight times the weight per unit area of said central region.

19. The wheel assembly defined in claim 11 wherein all the weft threads and warp threads of said central region are composed of nylon and the shrinkable warp threads of the selvage regions are composed of polyvinylalcohol.

20. The wheel assembly defined in claim 11 wherein all the weft threads and warp threads of said central region are composed of polyester and the shrinkable warp threads of the selvage regions are composed of polyvinylalcohol.
